(19) United States
(12) Patent Application Publication
(10) Pub. No.: US 2009/0280684 A1
(43) Pub. Date: Nov. 12, 2009

(54) ELECTRICAL CONNECTOR

(76) Inventors: Taizo Sogo, Tokyo (JP); Takayuki Arai, Tokyo (JP); Takeshi Sato, Tokyo (JP); Taku Kawano, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/436,907

(22) Filed: May 7, 2009

(30) Foreign Application Priority Data
May 8, 2008 (JP) 2008-122131

(51) Int. Cl. H01R 13/648

(52) U.S. Cl. 439/607.01

(57) ABSTRACT

An electrical connector capable of being assembled at improved efficiency. The connector includes an insulative housing having contact accommodation portions, which are closed by a cover member having lock means. Contacts with which a cable is connected are received in the contact accommodation portions of the housing. The housing is fabricated integrally with the cover member via a hinge. The cover member closes openings in the accommodation portions. The lock means has engagement pawls standing upright from the upper surface of the housing. When the accommodation portions are dosed, the engagement pawls come into engagement with engagement portions formed in the cover member.

### BACKGROUND OF THE INVENTION

1. Field of the Invention

The present invention relates to an insulator structure for use in an electrical connector and, more particularly, to the structure of a cover member made of an insulator used in an electrical connector which is fabricated by connecting a cable with contacts, mounting the contacts into accommodation portions with a press fit such that the contacts are supported to form an insulator housing, and surrounding the insulator housing with a shell to electrically shield the housing.

2. Prior Art

In one conventional electrical connector, the junction between each contact and a cable is surrounded by a metal shell via an insulator housing to electrically shield the junction. After the contacts are received in contact accommodation portions formed in an insulator, the openings of the accommodation portions are covered with an insulator cover member such that the cover member is interposed between each contact and the shell.

As shown in FIGS. 4A and 4B, the cover member 15 is often molded integrally with the housing body 16. The cover member is coupled to the housing body 16 via a hinge 16a. After a cable 18 is connected with the electrical connector 17, the cover member 15 is dosed to surround a shell for shielding.

As shown in FIGS. 4B and 4C, the electrical connector 17 is coupled to a receptacle connector 20 from a vertical direction, the connector 20 being surface-mounted on a printed circuit board 19. An electrical connector designed to have a low height in a corresponding manner to a recent small and lightweight electric or electronic device is known (see JPA-2006164791).

However, in the prior-art electrical connector 17, the cover member 15 is surrounded by a shell after the housing body 16 is dosed and, therefore, there is no means of locking the cover member. Accordingly, during assembly of the electrical connector 17, if the cover member 15 is dosed after the contacts connected with the cable 18 are received in the accommodation portions of the housing body 16, there is the danger that the cover member 15 is opened by the repulsive force of the hinge 16a because any lock means for holding the cover member closed is not available. Consequently, the cover member 15 may be closed or opened. This is undesirable for the assembly work, and makes difficult the work for surrounding the cover member with the shell. Hence, there is a problem that the efficiency of the assembly work is low.

### SUMMARY OF THE INVENTION

The present invention is intended to solve the foregoing problems with the prior art. It is an object of the invention to provide an electrical connector that can be assembled at an improved efficiency.

An electrical connector according to the present invention has contacts with which a cable is connected, an insulative housing, a cover member fabricated integrally with the housing via a hinge, and a metal shell. The housing has accommodation portions in which the contacts are accommodated. The cover member doses openings in the accommodation portions. When the accommodation portions are dosed by the cover member, the shell surrounds and electrically shields the housing except for a connection portion that is a given region necessary for connection with a mating member. The housing has lock means which, when the cover member has closed the accommodation portions, engages a part of the cover member, locking the cover member. As a result, the accommodation portions are kept dosed.

The locking member includes engagement pawls standing upright from the upper surface of the housing and engagement cutouts formed in the cover member and corresponding in position to the engagement pawls, each of which has a hook-shaped top portion. Preferably, when the accommodation portions are dosed, the engagement pawls come into intermeshing engagement with engagement cutouts in the cover member.

Preferably, the accommodation portions in the housing for receiving the contacts are plural in number and juxtaposed. A partitioning wall standing upright is formed to partition the accommodation portions. The cover member is provided with a fitting portion in which the partition wall is fitted.

In the electrical connector of the present invention, when the contacts connected with the cable are received in the accommodation portions in the insulative housing and the openings in the accommodation portions are dosed by the cover member, the lock means maintains the accommodation portions dosed. Therefore, if the resilient force of the hinge urges the cover member to open, the cover member is prevented from being opened. As a result, the posture assumed during assembly is made uniform and improved. A work for placing the shell from above under the condition where the accommodation portions are dosed by the cover member is facilitated. In consequence, the efficiency of the assembly work can be enhanced.

The lock means stands upright from the upper surface of the housing. When the accommodation portions are closed by the cover member, the engagement pawls make intermeshing engagement with the engagement cutouts in the cover member. As a result, they are locked together reliably.

Furthermore, electrical shorting between the contacts is prevented by forming the partition wall. The partition wall assists the locking action of the cover member.

### BRIEF DESCRIPTION OF THE DRAWINGS

FIGS. 1A, 1B, and 1C are a side elevation view, a bottom view, and a front elevation view, respectively, of an electrical connector according to a first embodiment of the present invention;

FIGS. 2A, 2B, and 2C are a plan view, a side elevation view, and a bottom view, respectively, of the electrical connector, and in which the insulative housing is open;

FIG. 2D is a side elevation view of the electrical connector according to the first embodiment of the invention, and in which the insulative housing is dosed;

FIGS. 3A and 3B are a plan view and a side elevation view, respectively, of an electrical connector according to a second embodiment of the invention, and in which the insulative housing is open;

FIG. 3C is a side elevation view of the electrical connector according to the second embodiment of the invention, and in which the insulative housing is closed;

FIGS. 4A and 4B are a plan view and a side elevation view of an electrical connector according to a prior-art example, and in which the housing is open; and

FIG. 4C is a side elevation view of the electrical connector according to the prior-art example, and in which the housing is dosed.

### DETAILED DESCRIPTION OF THE PREFERRED EMBODIMENTS

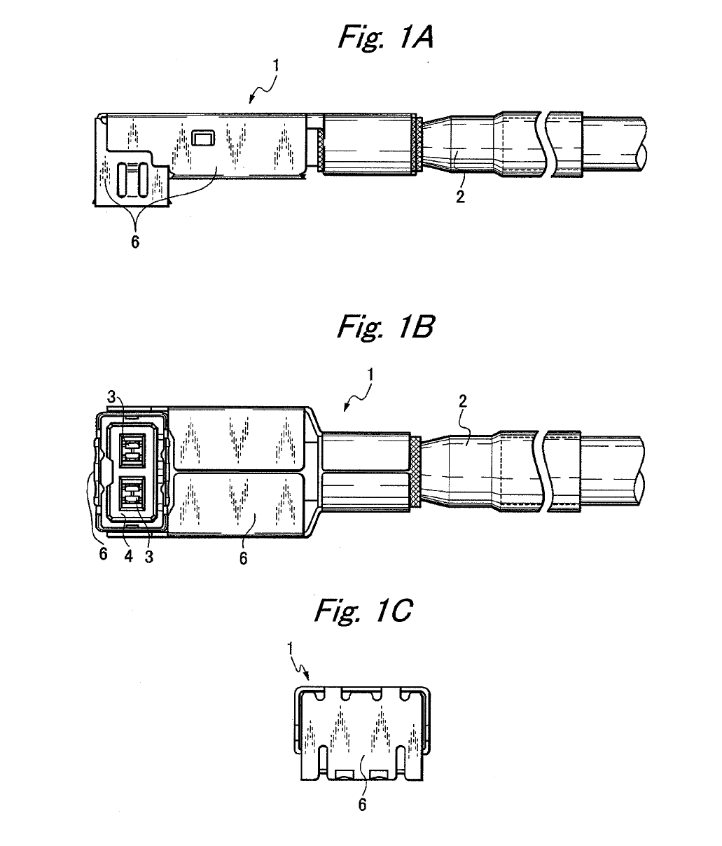

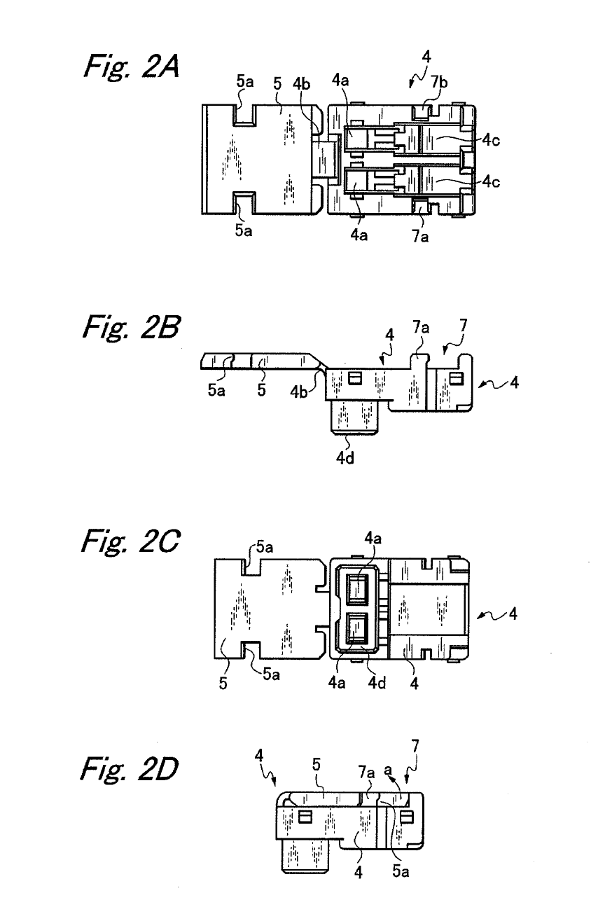

An electrical connector 1 according to the present invention includes contacts 3 (see FIGS. 1A-1C) connected with a cable 2 such as a signal line, an insulative housing 4 (see FIGS. 2A-2D) having accommodation portions 4a for receiving the contacts 3, a cover member 5 molded integrally with the housing 4 via a hinge 4b and acting to dose openings 4c in the accommodation portions 4a, and a metal shell 6. When the cover member 5 has been dosed, the shell 6 surrounds and electrically shields the housing 4 except for a connection portion 4d that is a given region in a surface to be connected with a mating member.

The housing 4 has lock means 7 which, when the cover member 5 is closed, engages a part of the cover member 5 and holds the cover member 5 closed. The lock means 7 is composed of engagement pawls 7a, 7b standing upright from the upper surface of the housing 4 and engagement cutouts 5a, 5a formed at the fringes of the cover member 5 on opposite sides. The pawls 7a and 7b are located on opposite sides. The engagement cutouts 5a, 5a correspond in position to the engagement pawls 7a and 7b, respectively. In particular, each of the engagement pawls 7a and 7b has a hook-shaped top portion. The engagement cutouts 5a, 5a have protrusive portions with which the engagement pawls 7a and 7b engage, respectively (see FIG. 2B).

The provision of the lock means 7 prevents the hinge 4b from rattling after the electrical connector has been assembled. Also, the work for assembling the shell 6 is facilitated. In addition, the cover member 5 is maintained dosed in the insulative housing 4. The electrical connector has improved aesthetic appearance. It is unlikely that the cover member opens halfway. Hence, the connector is easy to handle.

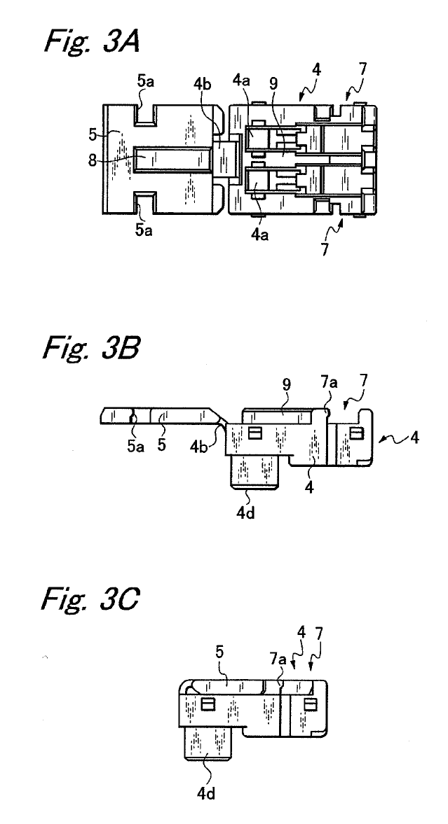

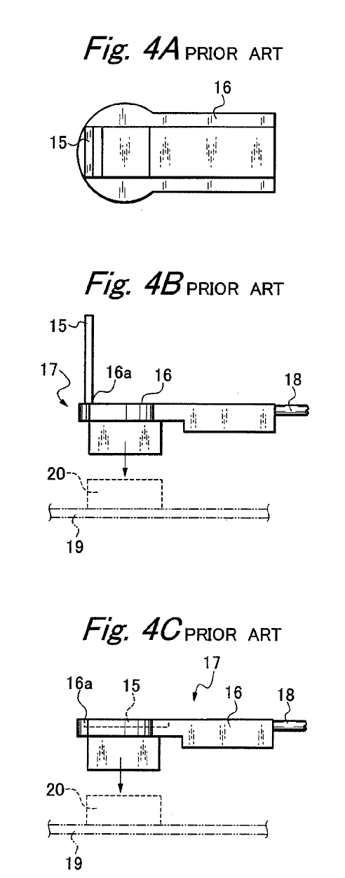

FIGS. 3A-3C show another example of the present invention. A partition wall 9 is formed between two juxtaposed accommodation portions 4a, 4a. The cover member 5 has a fitting portion 8 in which the partition wall 9 is fitted.

When the cover member 5 is dosed, the partition wall 9 fits into the fitting portion 8. It is assured that electrical shorting is prevented when the contacts 3 received in the juxtaposed accommodation portions 4a rise. Furthermore, the lock means 7 is assisted in dosing the cover member 5. That is, the dosed state of the cover member 5 is maintained more reliably.

What is claimed is:

1. An electrical connector comprising:
contacts with which a cable is connected;
an insulative housing having accommodation portions in which the contacts are received;
a cover member formed integrally with the housing via a hinge and acting to close openings in the accommodation portions; and
a metal shell which, when the housing has been closed by the cover member, surrounds and electrically shields the housing except for a connection portion that is a region necessary for connection with a mating member;
wherein the housing has lock means that, when the accommodation portions have been closed by the cover member, engages a part of the cover member and locks the cover member, thus maintaining the accommodation portions closed.

2. An electrical connector according to claim 1, wherein said lock means includes engagement pawls standing upright from an upper surface of the housing and engagement cutouts formed in the cover member and corresponding in position to the engagement pawls each of which has a hook-shaped top portion, and wherein when the openings are dosed, the engagement pawls are in intermeshing engagement with engagement members of the cover members.

3. An electrical connector according to claim 1,
wherein the accommodation portions in said housing for receiving the contacts are plural in number and juxtaposed,
wherein a partition wall partitioning the accommodation portions stands upright, and
wherein said cover member has a fitting portion in which the partition wall is engaged.

4. An electrical connector according to claim 2,
wherein a partition wall partitioning the accommodation portions stands upright, and
wherein said cover member has a fitting portion in which the partition wall is engaged.
